(19) United States
(12) Patent Application Publication
(10) Pub. No.: US 2010/0319623 A1
(43) Pub. Date: Dec. 23, 2010

(54) SQUIRREL PROOF FEEDER

(76) Inventor: John F. Trout, Geneva, IL (US)

Correspondence Address: TAYLOR IP, P.C., P.O. Box 560, 142. S Main Street, Avilla, IN, 46710, US

(21) Appl. No.: 12/853,909

(22) Filed: Aug. 10, 2010

Related U.S. Application Data
(63) Continuation-in-part of application No. 12/430,339, filed on Apr. 27, 2009.

(51) Int. Cl. A01K 39/01

(52) U.S. Cl. 119/57.9

(57) ABSTRACT

A bird feeder for effectively deterring squirrels and other unwanted animals from accessing the bird feed deposited therein. The bird feeder includes at least two detachable feeder bins positioned along an edge of a central module of the feeder and a pivot device removably coupled with the central module and positioned at approximately a center of a diameter of said central module.

### CROSS REFERENCE TO RELATED APPLICATIONS

This is a continuation-in-part of U.S. patent application Ser. No. 12/430,339, entitled “SQUIRREL PROOF BIRDFEEDER”, filed Apr. 27, 2009, which is incorporated herein by reference.

### BACKGROUND OF THE INVENTION

1. Field of the Invention

The present invention relates to a bird feeder, and, more particularly, to a squirrel proof bird feeder.

2. Description of the Related Art

The study of birds, formally known as ornithology, is a rapidly growing field. Within the field, there are a vast range of enthusiasts from researchers to hobbyists and their numbers are ever increasing. As a result, there is a growing market for methods to attract wild birds to a particular location. The most effective method of attracting birds to a particular site is to provide an attractive environment, which includes suitable nesting sites, minimization of predators, water, and provision for nutritional needs which may be directed to a particular species or a wide range of species. In order to provide for one of the many needs of a variety of birds, numerous bird feeders have been developed for the purpose of attracting birds to a particular site for the enjoyment of bird enthusiasts. This objective has, however, been met with a wide range of challenges. Specifically, a common problem associated with bird feeders is the tendency to attract unwanted animals, for example, squirrels. Squirrels will not only feed at bird feeders, but also raid, or carry food away to their hoard, thereby depleting the available food for desirable birds and potentially destroying the bird feeder in the process. By depleting the available food stock and by their mere presence, squirrels deter desirable wild birds from visiting a site.

There have been a number of attempts to develop an effective squirrel proof bird feeder which are known in the prior art. A complex squirrel deterrent bird feeder system is disclosed in U.S. Pat. No. 6,119,627 (Banyas et al.), specifically, a cylindrical rodent repelling bird feeder including an annular perch and an electric motor geared to the perch. The perch is coupled with the electric motor and the electric motor is reciprocatively mounted in the bird feeder so that when a rodent of excessive weight alights upon the perch the motor is pulled against a resistance spring and a switch is caused to close, thereby engaging the motor which rotates the perch to dislodge the rodent. The complexity of the device and necessity for a supply of electricity make this bird feeder costly to produce and add an additional expense for operation.

U.S. Pat. No. 5,720,238 (Drakos) discloses a spring operated squirrel proof bird feeder including an inner and outer housing with the inner housing fixed vertically with the outer housing telescopically received thereabout and moveable between upper and lower positions. The housings have openings which are aligned and which provide through openings serving as feed ports in the upper position of the outer housing. In the lower position of the outer housing, the openings are misaligned and close the feed ports. The outer housing is also provided with springs biasing the same toward the upper position but allowing the housing to move downwardly to the lower position under the weight of the squirrel. Again, the complexity of the feeder results in high expense in both labor and materials.

U.S. Pat. No. 5,170,750 (Ricketts) discloses a bird feeder including a spring-actuated roof which acts as a catapult when an animal alights thereon. The roof is secured by a latch which disengages when spring loaded pistons urge the roof upward and it can be closed and resecured either manually or automatically by motor. A common problem with existing weight sensitive squirrel deterrent systems is that the weight is set, by the tension of the spring or otherwise, therefore, the system may not be effective in deterring small or immature squirrels from raiding the feeder.

What is needed in the art is a bird feeder which effectively deters squirrels from accessing bird feed deposited therein and destroying the bird feeder.

### SUMMARY OF THE INVENTION

The present invention provides a bird feeder which effectively deters squirrels and other unwanted animals from accessing the bird feed deposited therein. The bird feeder includes a pair of feeder bins positioned at generally opposite ends of the feeder and a pivot device positioned approximately midway between and removably coupled with the pair of feeder bins. Each of the feeder bins has an L-shaped cross-section. The stability of the feeder is easily varied by vertically relocating a horizontal support, which may be a pin, plate, a bolt or a wire. The horizontal support is removeably attached to the feeder in a recess formed between the pair of feeder bins. On each side of the recess and attached to the feeder bins there may be a series of protrusions, slots or holes positioned to correspond with a another set of protrusions, slots or holes located on the opposite feeder bin. The protrusions may extend from the feeder bin itself or may extend from a plate or the like attached to each of the feeder bins. Alternatively, the plurality of corresponding slots or holes may be included in the walls of the recess or in plates or the like attached to each of the feeder bins. Relocation of the horizontal support along one of the pairs of the corresponding protrusions, slots or holes, in association with the pivot device, provides sufficient instability to the feeder to discourage squirrels from raiding the feed contained therein.

In one embodiment of the present invention, the bird feeder may be mounted to a suspension wire having a ball at one end, the ball positioned within a conical recess of the pivot device, thereby movably coupling the suspension wire with the pivot device. The suspension wire extends through a slot in the roof allowing the wire to remain plumb with a hinge point on the pivot device. The stability of the feeder can be adjusted by relocating the horizontal support in a vertical direction.

In a second embodiment of the present invention, the bird feeder may be mounted on a post. In this embodiment, the post may include an elongate protrusion which, when coupled with the bird feeder, extends into the conical recess of a socket included in the pivot device. Thus, when trying to access the food stock by climbing up the post, a squirrel is met by the conical recess of the socket, which provides another barrier for the squirrel to get past.

Alternatively, the vertical support may include a pair of beams extending into the recess between the bins of the bird feeder. The vertical support may be mounted to the feeder by a pin, bolt or wire extending through a pair of holes of a series of corresponding holes included in the pair of beams extending vertically into the recess between the feeder bins. In this case, the horizontal support, in the form of a pin, wire or bolt, is operable coupled with the vertical support such that horizontal support itself provides the hinge point. Relocation of the pin, wire or bolt in a vertical direction adjusts the stability of the bird feeder.

A third embodiment of the present invention provides a bird feeder having a central module, a pivot device and at least two feeder bins which are removably coupled or detachable from the central module of the feeder and positioned in relation to a center of gravity of the central module. The pivot device is removably coupled with the central module of the bird feeder. For example, a generally vertical back wall or rear panel of the feeder bin is coupled with a substantially vertical side wall of the central module.

In this case, the feeder bins may be attached to the central module by, for example, a locking mechanism, a clamping mechanism or a latch mechanism. In the case where a latch mechanism is utilized to couple the central module with one of the feeder bins, when the latch is in the unlocked position, the feeder bin may be removed for cleaning and refilling. When the latch is in the locked position, the feeder bin is securely coupled to the central module of the feeder.

In this embodiment, the vertical support or post may further be positioned within a pipe or tube driven into the ground. Additionally, the length of the post may be adjustable by resetting the location of a collar seated in the pipe or tube.

The feeder bins have an L-shaped cross section and may weigh, for example, less than approximately 1 lb. The feeder bins may further vary in size. The feeder bins may, for example, be configured to hold approximately 1½ quart or more, for example, 3 quarts of seed. The post may be, for example, stainless steel, wood or pipe. Each of the components of the bird feeder may be formed a variety of materials, for example, wood, stainless steel, copper, brass or PVC. In addition, the bird feeder of the present invention includes a single roof removable and overlying the central module and each of the feeder bins. The bird feeder according to the present invention further includes a single roof removably coupled with and overlying the central module and each bin.

This embodiment includes a biasing mechanism for stabilization of the feeder for purposes, for example, of refilling the feeder bins. The biasing mechanism is configured to interface with the vertical post and the central module of the feeder. The biasing mechanism may, for example, be a wire having a first portion which extends from a second linear portion of the wire, the first portion being a short leg which is substantially perpendicular to the second linear portion of the wire. At an end opposite the first portion and extending from the second portion of the wire is a third portion configured in the form of a quasi spiraled end having a linear axis substantially parallel to the first portion. In this example, the third quasi spiraled portion of the wire is configured to interface with and lock around the post of the feeder such that when the third quasi spiraled portion of the wire is placed around the post, the end of the first portion or short leg of the wire is pointed down. The first portion of the wire is further configured to interface with the central module of the feeder. More specifically, the first portion is configured to slide into a groove in the wall of the central module which extends behind a portion of the bracket which is affixed to the central module. In this manner, the feeder is stabilized and the feeder bin(s) may be removed, refilled and replaced.

As an option, the present invention may also include a boost stick having a slit along the length of same, which is removably coupled with the post. The boost stick enables the user to retrieve the bird feeder for refilling from a greater height than the user's natural reach by using the boost stick to push the feeder up and off the post. An advantage of this option is that the boost stick allows the user to place the feeder on a taller post, which is an attractive feature for many bird enthusiasts.

An advantage of the present invention is that the device is an effective way of deterring squirrels from raiding the food stores located within the bird feeder of the present invention. A visit to the feeder of the present invention by a squirrel will be met with instability sufficient to dislodge the squirrel, thereby, thwarting any effort to raid the stores within, resulting in a maximum available food source for desirable wild birds.

Another advantage of the present invention is that the simplicity of the device provides for reduced cost and labor in manufacturing the device and simplicity in use.

A further advantage of the present invention is the ease with which the bird feeder can be cleaned. By simply removing the lid, the feeder bins are easily accessible for cleaning before replenishing the food stock.

Yet another advantage is the provision of the boost stick, which allows the user to place the bird feeder at a greater height, often providing better visibility and a more attractive environment for desirable wild birds.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a side view of an embodiment of the bird feeder of the present invention;

FIG. 2 is a top view of the bird feeder shown in FIG. 1;

FIG. 3 is an end view of the bird feeder shown in FIGS. 1 and 2;

FIG. 4 is a schematic illustration of a portion of another embodiment of a bird feeder of the present invention;

FIG. 5 is a side view of a mounting post and boost stick of the present invention which may be used with the bird feeder shown in FIGS. 1-3;

FIG. 6 is a sectional view of the mounting post and boost stick shown in FIG. 5, taken along line 6-6 in FIG. 5;

FIG. 7 is a side view of another embodiment of the bird feeder of the present invention;

FIG. 8 is an exploded view of an embodiment of the bird feeder of the present invention;

FIG. 9 is an exploded view of an embodiment of the bird feeder of the present invention;

FIG. 10 is a schematic illustration of the locking mechanism of the bird feeder of the present invention in a locked position;

FIG. 11 is a schematic illustration of the locking mechanism of the bird feeder of the present invention in an unlocked position;

FIG. 12 is a schematic illustration of biasing mechanism of the bird feeder of the present invention; and

FIG. 13 is a schematic illustration of the biasing mechanism of the bird feeder of the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

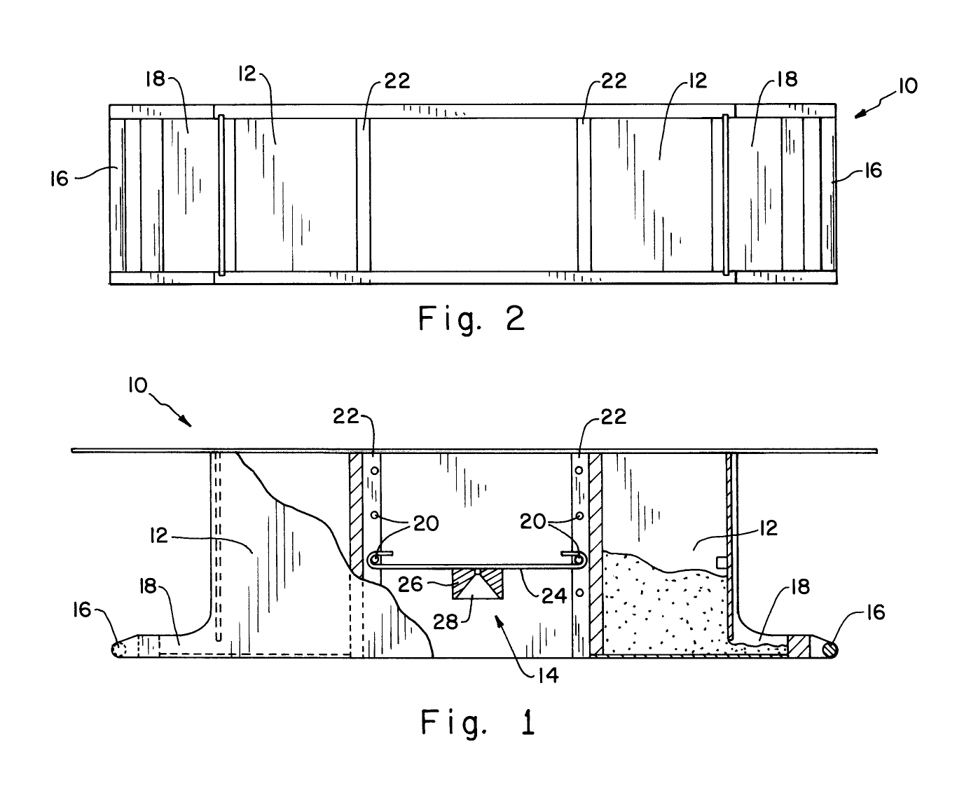

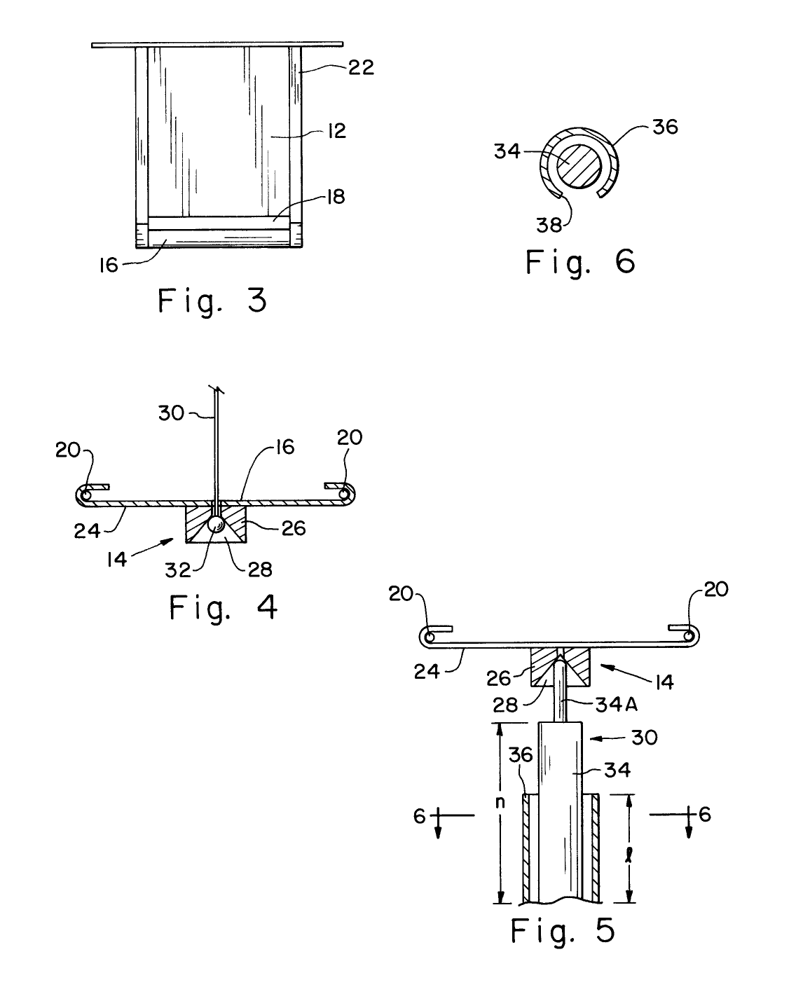

Referring now to the drawings, and more particularly to FIGS. 1-3, there is shown a bird feeder 10 which generally includes a pair of feeder bins 12 and pivot device 14 positioned approximately midway between and removably coupled with the pair of feeder bins 12. Feeder bins 12 are positioned at generally opposite ends of bird feeder 10. Each of feeder bins 12 includes at least one perch 16 and at least one feeding trough 18. Bird feeder 10 further includes a series of corresponding protrusions 20 extending directly from each of feeder bins 12 or, in the alternative, from at least two plates 22, which are connected to each of feeder bins 12. Horizontal support 24 is movably engaged with a plurality of corresponding protrusions, slots or holes 20 and may include a plate, a pin, a wire, or any combination thereof.

Pivot device 14 includes socket 26 having conical recess 28 therein and is connected to horizontal support 24 such that pivot device 14 is positioned approximately midway between and removably coupled with feeder bins 12. Pivot device 14 is adjustably movable in vertical directions relative to each of feeder bins 12 by relocating horizontal support 24 on a different pair of corresponding protrusions 20, thus providing the predetermined instability sufficient to dislodge unwanted animals from the feeder.

Referring now to FIG. 4, bird feeder 10 may optionally include a vertical support member 30 engaged with pivot device 14. In one embodiment of the present invention, vertical support member 30 is a suspension wire. Ball 32 is connected to an end of suspension wire 34 and is positioned within a socket 28 having a conical recess, ball 32 being movably engaged with pivot device 14. Pivot device 14, which is movably engaged with ball 32, is adjustably movable in a vertical direction relative to each of feeder bins 12 by relocating horizontal support 24 on a different pair of corresponding protrusions 20, thereby providing the predetermined instability sufficient to dislodge unwanted animals from the feeder.

Referring now to FIGS. 5 and 6, there is shown another embodiment of the present invention wherein the vertical support member is a post 34. Post 34 includes an elongate protrusion 34A configured to be movably engaged with pivot device 14. Pivot device 14, which is movably engaged with post 34, is adjustably movable in a vertical direction relative to each of feeder bins 12 by relocating horizontal support 24 on a different pair of corresponding protrusions 20, thereby, providing the predetermined instability sufficient to dislodge unwanted animals from the feeder.

The embodiment of the present invention shown in FIGS. 5 and 6 may further include a boost stick configured to fit around and be removably engaged with post 34. Boost stick 36 has a length l along which a slit 38 extends and which is less than the length n of post 34. Boost stick 36 is configured to be movably engaged with the bird feeder such that it may be slid up and along post 34 to lift the feeder off post 34, allowing for placement of the feeder at a greater height while still allowing for easy access to the feeder.

The bird feeder 10 including vertical support member in the form of post 34 may further include a biasing mechanism 62 for stabilization of the feeder for purposes, for example, of refilling the feeder bins. The biasing mechanism 62 is configured to interface with post 34 and central module 44 of the feeder. Biasing mechanism 62 may, for example, be a wire having a first portion 64 which extends from a second linear portion 66 of the wire, the first portion 64 being a short leg which is substantially perpendicular to the second linear portion 66 of the wire. At an end opposite the first portion 64 and extending from the second portion 66 of the wire is a third portion 68 configured in the form of a quasi spiraled end having a linear axis s substantially parallel to the first portion 64. In this example, the third quasi spiraled portion 68 of the wire is configured to interface with and lock around post 34 of the feeder such that when the third quasi spiraled portion 68 of the wire is placed around post 34, the end 70 of the first portion 64 or short leg of the wire is pointed down. The first portion 64 of the wire is further configured to interface with the central module 44 of the feeder. More specifically, the first portion 64 is configured to slide into groove 72 in the wall of the central module 44 which extends behind a portion of the bracket 54 which is affixed to the central module 44. In this manner, the feeder is stabilized and the feeder bin(s) 12 may be removed, refilled and replaced.

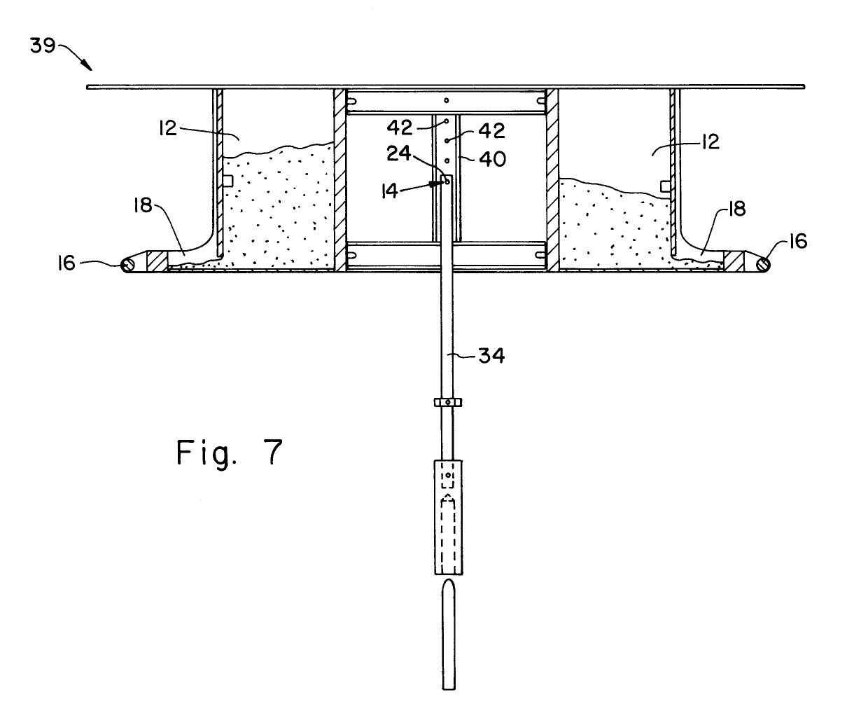

Referring now to FIG. 7, there is shown another embodiment of a bird feeder 39 having post 34 including a pair of beams 40 (one of which is shown). Post 34 may be mounted to bird feeder 39 by horizontal support 24 in the form of a pin, wire or bolt which extends through a pair of holes 42 of a series of corresponding holes included in the pair of beams 40. In this case, post 34 is operably coupled with bird feeder 39 such that horizontal support 24 is pivot device 14. Relocation of horizontal support 24 in a vertical direction adjusts the stability of bird feeder 39 sufficiently to dislodge an unwanted visitor from the feeder.

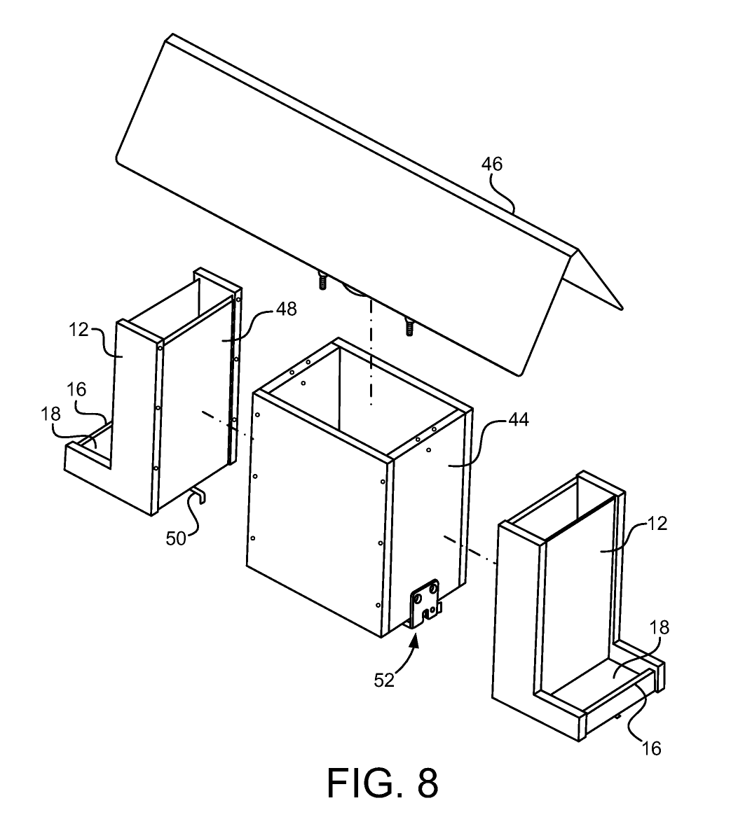

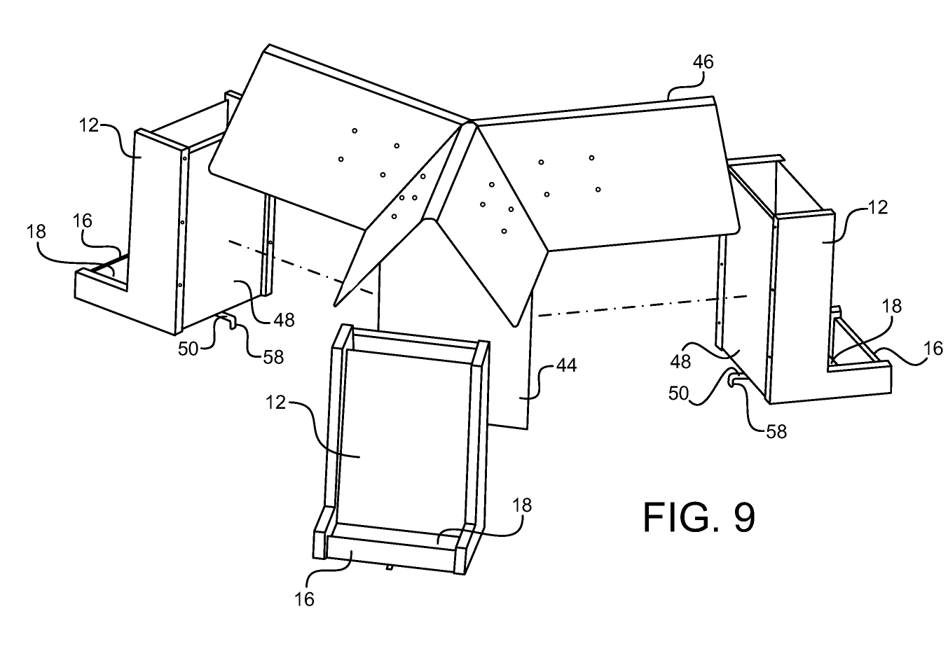

Referring now to FIGS. 8-11, there are shown embodiments of bird feeder 10 including central module 44, detachable feeder bins 12, and roof 46. In this embodiment, pivot device 14 is removably coupled with central module 44 and is positioned in relation to a center of gravity of central module 44. Each feeder bin 12 has a generally L-shaped cross-section and includes feeder trough 18 and perch 16. Additionally, roof 46 is removably coupled with and configured to overlay central module 44 and each of feeder bins 12.

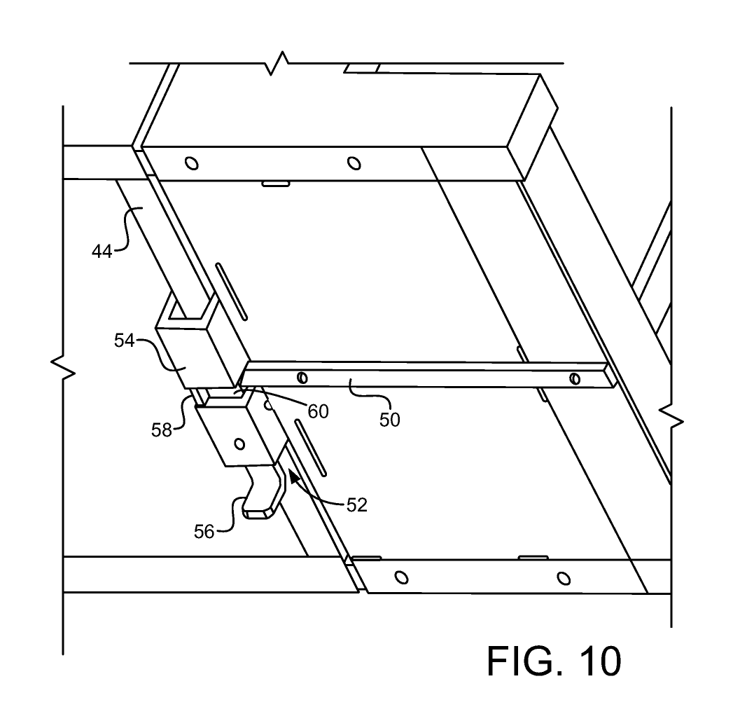

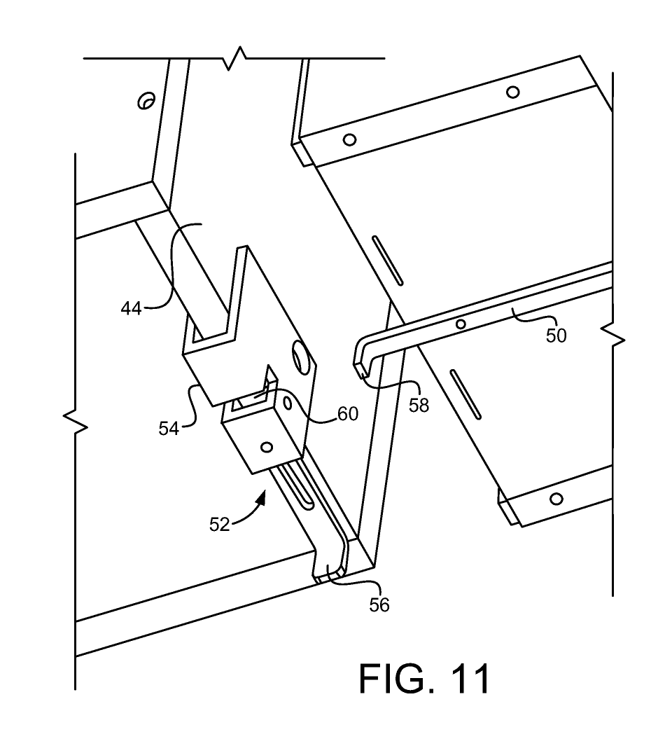

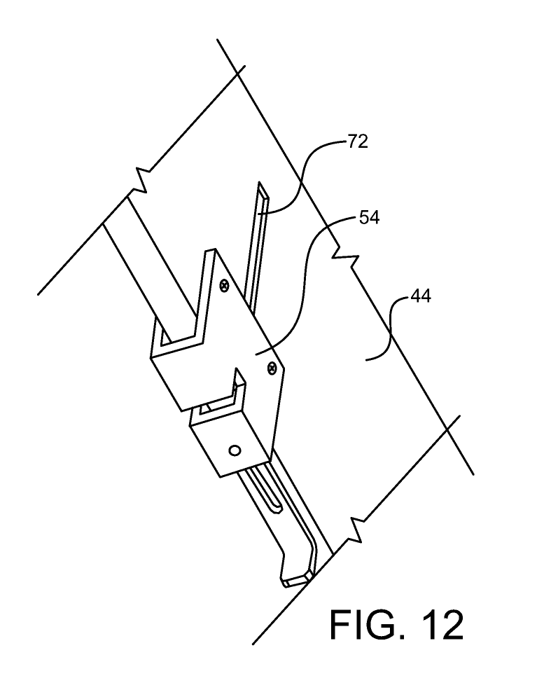

Substantially vertical back walls or rear plates 48 of feeder bins 12 are configured to abut a substantially vertical side wall or portion of central module 44 and are coupled to central module 44 with, for example, latch mechanism 52 such that pin 50 extending from feeder bin 12 is configured to engage latch mechanism 52. Latch mechanism 52 includes bracket 54 and slide 56. Feeder bin 12 is affixed to central module 44 when bent portion 58 of pin 50 is passed through opening 60 of bracket 54 and slide 56 passed over pin 50 into a locked position, as illustrated in FIG. 10. Conversely, feeder bin 12 is detachable from central module 44 by placing slide 56 in the unlocked position such that pin 50 is disengaged from latch mechanism 52, illustrated in FIG. 11. Alternatively, feeder bins 12 may be removably coupled with central module 44 with, for example, a lock mechanism or a clamp mechanism.

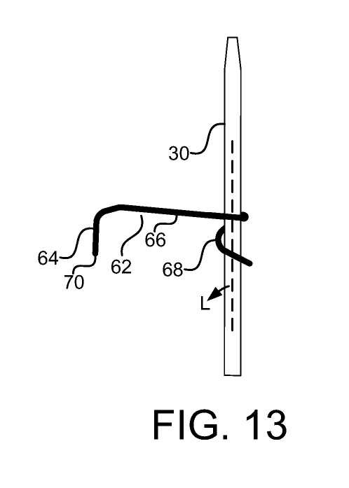

The embodiment includes a biasing mechanism for stabilization of the feeder for purposes, for example, of refilling the feeder bins. Referring now to FIGS. 12 and 13, there is shown biasing mechanism 62 configured to interface with vertical support member 30 and the central module 44 of the feeder. The biasing mechanism 62 may, for example, be a wire having a first portion 64 which extends from a second linear portion 66 of the wire, the first portion 64 being a short leg which is substantially perpendicular to the second linear portion 66 of the wire. At an end opposite the first portion 64 and extending from the second portion 66 of the wire is a third portion 68 configured in the form of a quasi spiraled end having a linear axis l substantially parallel to the first portion 64. In this example, the third quasi spiraled portion 68 of the wire is configured to interface with and lock around the vertical support member 30 of the feeder such that when the third quasi spiraled portion 68 of the wire is placed around the vertical support member 30, the end 70 of the first portion 64 or short leg of the wire is pointed down. The first portion 64 of the wire is further configured to interface with the central module 44 of the feeder. More specifically, the first portion 64 is configured to slide into a groove 72 in the wall of the central module 44 which extends behind a portion of the bracket 54 which is affixed to the central module 44. In this manner, the feeder is stabilized and the feeder bin(s) may be removed, refilled and replaced.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A bird feeder comprising:
a central module;
at least a two feeder bins removably coupled with said central module and located at generally opposing sides of said central module; and
a pivot device positioned in relation to a center of gravity of said central module.

2. The bird feeder according to claim 1, wherein said pivot device is adjustably movable in vertical directions relative to each of said feeder bins.

3. The bird feeder according to claim 2, further comprising a horizontal support connected to said pivot device and a vertical support member movably engaged with said pivot device, wherein said vertical support member is one of a rod and a post.

4. The bird feeder according to claim 3, wherein a length of said vertical support member is adjustable.

5. The bird feeder according to claim 4, further comprising a biasing mechanism configured to interface with said vertical support member and said central module to stabilize said central module.

6. The bird feeder according to claim 5, wherein the biasing mechanism is a wire having a first portion extending from a second linear portion of the wire, said first portion being a short leg substantially perpendicular to said second linear portion and a third portion at an end opposite said first portion and extending from said second linear portion of said wire, said third portion being configured as a quasi spiraled end having a linear axis substantially parallel to said first portion.

7. The bird feeder according to claim 6, wherein said first portion is configured to interface with said central module and said third portion is configured to interface with said vertical support member.

8. The bird feeder according to claim 1, wherein said at least two feeder bins includes three feeder bins.

9. The bird feeder according to claim 1, wherein a substantially vertical back wall of each of said at least two feeder bins is coupled with a substantially vertical side wall of said central module.

10. The bird feeder according to claim 1, wherein each of said at least two feeder bins is affixed to said central module with a latch mechanism.

11. The bird feeder according to claim 10, wherein the latch mechanism includes a bracket and a slide.

12. The bird feeder according to claim 11, wherein each of said at least two feeder bins includes a pin extending beyond a rear panel of each of said feeder bins and configured to engage said latch mechanism, said pin having a bent portion at an end of said pin.

13. The bird feeder according to claim 12, wherein said latch mechanism has a locked position and an unlocked position, said feeder bin being affixed to said central module when said latch mechanism is in said locked position and engaged with said pin and said feeder bin being released from said central module when said latch position is in said unlocked position and said pin disengaged from said latch mechanism.

14. The bird feeder according to claim 13, wherein said central module includes a plurality of corresponding pairs of one of protrusions, slots and holes, said horizontal support being adjustably connected to a pair of said plurality of corresponding pairs.

15. The bird feeder according to claim 1, wherein said pivot device is removably coupled with said central module.

16. The bird feeder according to claim 1, wherein said at least two feeder bins have an L-shaped cross-section.

17. The bird feeder according to claim 1, further comprising a single roof overlying said central module and said at least two feeder bins, wherein said roof is removably coupled with said central module and said at least two feeder bins.

18. A bird feeder comprising:
a central module;
at least two feeder bins removably coupled with said central module and positioned at generally opposing sides of said central module; and
a pivot device removably coupled with said central module and positioned in relation to a center of gravity of said central module.

19. The bird feeder according to claim 18, wherein each of said at least two feeder bins is affixed to said central module with a latch mechanism.

20. The bird feeder according to claim 19, wherein the latch mechanism includes a bracket and a slide.

21. The bird feeder according to claim 19, wherein each of said at least two feeder bins includes a pin extending beyond a rear panel of each of said feeder bins and configured to engage said latch mechanism, said pin having a bent portion at an end of said pin.

22. The bird feeder according to claim 21, wherein said latch mechanism has a locked position and an unlocked position, one of said feeder bins being affixed to said central module when said latch mechanism is in said locked position and engaged with said pin of said one feeder bin and said one feeder bin being released from said central module when said latch position is in said unlocked position and said pin of said one feeder been disengaged from said latch mechanism.

23. The bird feeder according to claim 18, wherein said central module includes a plurality of corresponding pairs of one of protrusions, slots and holes, a horizontal support being adjustably connected to a pair of said plurality of corresponding pairs.
